(19) United States
(12) Patent Application Publication
(10) Pub. No.: US 2023/0365224 A1
(43) Pub. Date: Nov. 16, 2023

(54) DEVICE FOR ASSISTING THE MOVEMENT OF A LOAD

(71) Applicant: UNIVERSITÉ DE VERSAILLES SAINT QUENTIN EN YVELINES, VERSAILLES Cedex (FR)

(72) Inventor: Eric MONACELLI, VELIZY (FR)

(21) Appl. No.: 18/029,892

(22) PCT Filed: Nov. 29, 2021
(86) PCT No.: PCT/EP2021/083308

§ 371 Date: Mar. 31, 2023

(30) Foreign Application Priority Data
Nov. 30, 2020 (FR) FR2012423

(51) Int. Cl. B62M 7/12; B62J 45/415; B62L 1/00

(52) U.S. Cl. CPC B62M 7/12; B62J 45/4151; B62L 1/00

(57) ABSTRACT

A device for assisting the movement of a load along a surface, the device includes a one-wheeled gyropod equipped with a motorized wheel intended to roll along the surface, with a frame, and with at least one gyroscopic sensor making it possible to measure an inclination of the frame, the gyroscopic sensor controlling the motorization of the wheel, two lateral supports connected to the frame and able to move along the surface, a mechanism for braking each of the two lateral supports, configured to brake the movement of the lateral support in question along the surface as a function of a reaction force exerted by the surface on the lateral support in question.

The invention relates to a device for assisting the movement of a user and more particularly of a person with reduced mobility. The device may be used by an able-bodied person. It may also be used to move an immobile load. The device may be used as a wheelchair on which the user takes up position.

The majority of wheelchairs have four wheels in order to ensure the stability of the user. These wheelchairs are bulky. They occupy a large ground area which may reduce their ability to maneuver easily and notably in confined spaces. Their bulkiness often results in a significant weight. Four-wheeled chairs may be motorized. The electric motorization and the associated batteries have to be adapted to the weight of the user and to that of the chair itself. The heavier a chair is, the heavier the equipment required for the motorization thereof is as well.

In order to reduce the mass and the bulkiness of the chairs, tests have been carried out with two-wheeled chairs such as for example described in patent application WO 2018/096175 A1. To ensure the stability of the chair, use is made of a platform on an inverted pendulum of the two-wheeled gyropod type.

Furthermore, there are movement assistance devices based on a one-wheeled gyropod, often called an electric gyrowheel or unicycle. The gyrowheel comprises a single faired, motorized wheel. The user stands on rests secured to the fairing and disposed on either side of the wheel. The motorization of the wheel is commanded by an imbalance of the user toward the front or toward the rear. Gyroscopic sensors detect the imbalances of the user and command the motor as a function of the detected imbalance. Turns can be carried out by dissociating the movements of the upper body and the lower body. The user orients their shoulders in the desired direction and modifies the bearing of their feet and of the lower part of their legs against the fairing and the rests in order to perform a turn. Some very experienced users can even rotate on the spot, often called spinning. The gyrowheels currently available on the market are lightweight, compact and enable maneuvers in confined spaces. However, the usage of the gyrowheel is restricted to able-bodied users. It is completely impossible for paraplegic users to use them. It also appears difficult to propose such an item of equipment for elderly people or those in the course of functional re-education owing to fall risks.

The invention aims to propose a movement assistance device of greatly reduced bulkiness, which allows a large number of maneuvers, notably inclinations and spins, and which is accessible to people with reduced mobility.

To this end, the subject of the invention is a device for assisting the movement of a user along a surface such as the ground, the device being based on a gyrowheel and being equipped with accessories which make it safe to use for all types of users. More specifically, the device comprises:
a one-wheeled gyropod equipped with a motorized wheel rotating about an axis, the wheel being intended to roll along the surface, with a frame with respect to which the wheel is motorized, and with at least one gyroscopic sensor making it possible to measure an inclination of the frame with respect to a horizontal direction perpendicular to the axis of rotation of the wheel, the gyroscopic sensor controlling the motorization of the wheel,
two lateral supports connected to the frame and able to move along the surface,
a mechanism for braking each of the two lateral supports, configured to brake the movement of the lateral support in question with respect to the surface as a function of a reaction force exerted by the surface on the lateral support in question.

In one embodiment of the invention, each lateral support comprises a lateral caster able to roll along the surface, each being able to rotate with respect to a mount connected to the frame.

Each braking mechanism may comprise a pivot connection about a horizontal axis perpendicular to the axis of the wheel, the pivot connection connecting the mount to the frame, a pad secured to the mount being able to bear against the surface alternatingly with the rolling of the lateral caster along the surface, a return spring disposed between the mount and the frame tending to move the pad away from the surface and allowing the rolling of the lateral caster in question in the absence of reaction force exerted by the surface on the lateral caster in question.

Each of the lateral supports may be connected to the frame by means of a sliding connection connecting the frame to the corresponding lateral support, a spring tending to return the sliding connection to a medial position, and a damper for damping the movements of the sliding connection around its central position, the orientation of each sliding connection being defined so as to allow a compression of the damper in question when a reaction force of the surface on the lateral support in question increases.

The device may further comprise a lever associated with each of the casters, each lever being articulated to the frame at one point and to one end of the corresponding sliding connection at another separate point, the other end of the sliding connection being articulated to the frame, the pivot connection connecting the corresponding mount to the lever, the return spring being disposed between the mount and the lever.

The device may further comprise a platform configured to receive the load, the platform being movable in translation with respect to the frame along an axis of translation parallel to the axis of the wheel, an actuator making it possible to move the platform with respect to the frame along the axis of translation, a human-machine interface configured to allow a user to control the device, and a controller making it possible to command the actuator so as to move the platform with respect to the frame as a function of data from the human-machine interface.

The device may further comprise at least one attitude sensor for a user having taken up position on the device, the controller being configured to control the motorized wheel as a function of data from the attitude sensor.

The controller may be configured to control the actuator making it possible to move the platform as a function of data from the gyroscopic sensor and/or the attitude sensor.

The controller may be parameterizable.

The device may further comprise means for storing control and command data for the motorization of the wheel over a given period of time and for processing this data so as to edit an activity report of the user.

The device may further comprise a plurality of stops secured to the frame and configured to bear against the surface when the device reaches an inclination of an axis passing through the center of the wheel and through a contact point of the wheel with the surface during the rolling of the wheel along the surface with respect to a vertical axis passing through the contact point of the wheel, the stops being distributed about the axis passing through the center of the wheel and through the contact point of the wheel with the surface during rolling.

The position of the stops with respect to the frame may be adjustable.

The invention will be understood better and further advantages will become apparent on reading the detailed description of an embodiment given by way of example, the description being illustrated by the appended drawing, in which:

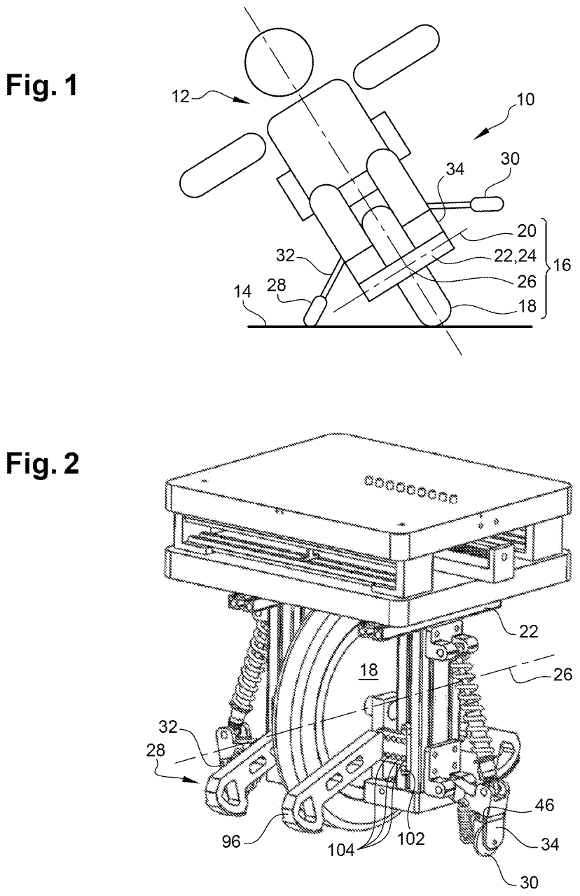

FIG. 1 schematically shows a user using a device according to the invention;

FIG. 2 shows a perspective view of a more specific example of a device according to the invention;

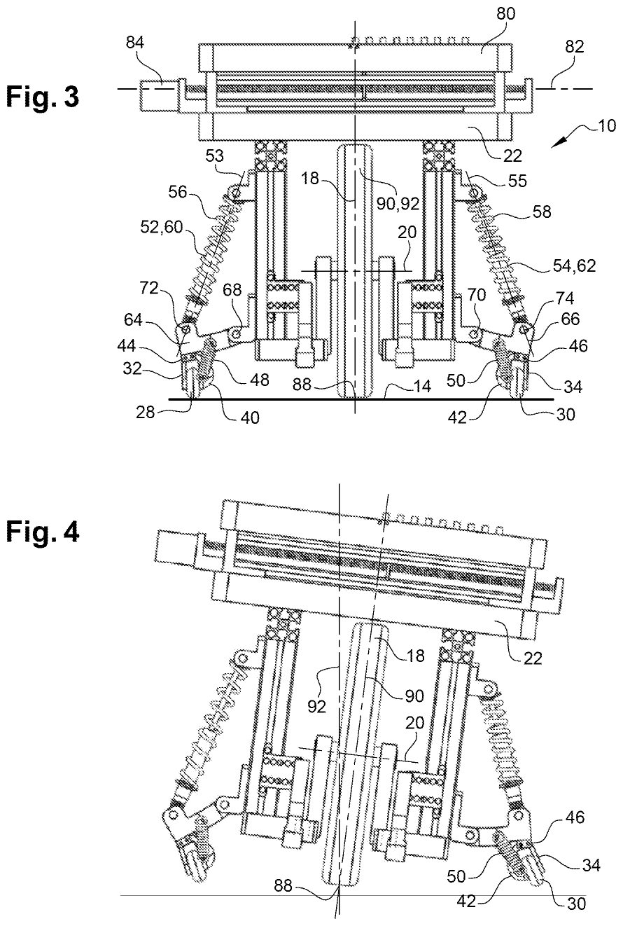

FIGS. 3, 4 and 5 show a front view of the device in FIG. 2 in three lateral inclination positions;

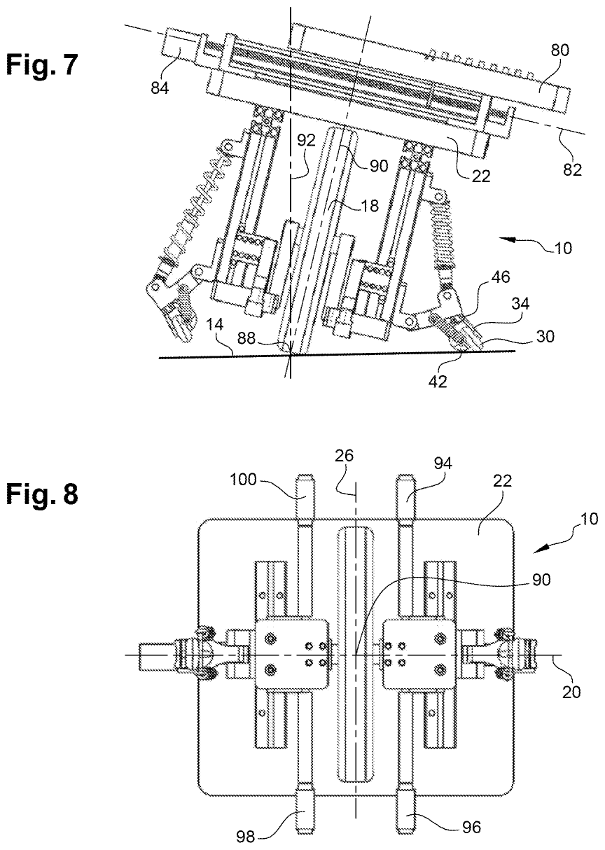

FIGS. 6 and 7 show a front view of the device in FIG. 2 in two lateral inclination positions that are assisted by the lateral movement of a platform;

FIG. 8 shows a top view of the device in FIG. 2;

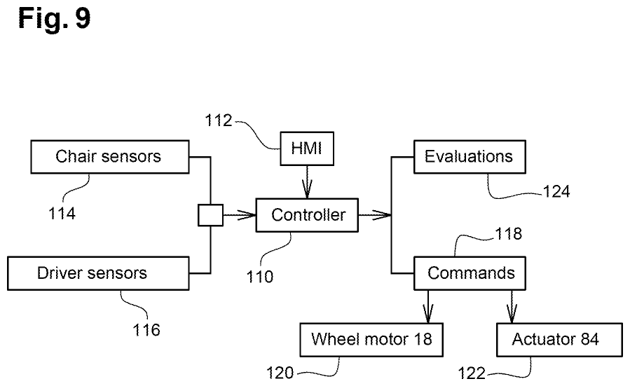

FIG. 9 illustrates, in the form of a block diagram, an example of operation of a device according to the invention.

For the sake of clarity, the same elements will bear the same references in the various figures.

FIG. 1 shows a device 10 for assisting the movement of a user 12 along a surface such as the ground 14. The ground 14 forms a planar and horizontal surface in FIG. 1. It is also possible to make the device move along a sloping or slightly uneven surface. In FIG. 1, the user has taken up position on the device. It is also possible to position an immobile load, or even no load, on the device.

The device 10 comprises a one-wheeled gyropod 16. At present, a number of manufacturers offer types of equipment, such as: Kingsong, Gotway, Inmotion, Solowheel, Ninebot, IPS, etc. The majority of the one-wheeled gyropods offered by these manufacturers can be integrated into the device 10. More specifically, a one-wheeled gyropod 16 comprises a motorized wheel 18 rotating about an axis 20, a frame 22 with respect to which the wheel 18 is motorized, and at least one gyroscopic sensor 24 disposed in the frame 22. The wheel 18 is intended to roll along the ground 14 so as to move the device 10. The gyroscopic sensor 24 is configured to measure an inclination of the frame 22 with respect to a horizontal direction 26 perpendicular to the axis of rotation 20 of the wheel 18. The gyroscopic sensor 24 controls the motorization of the wheel 18 so as to make the one-wheeled gyropod 16 move forward or backward. The horizontal direction 26 is defined for a nominal use of the one-wheeled gyropod 16. It represents the direction in which the one-wheeled gyropod 16 travels when the latter moves forward in a straight line. A motor (not shown) drives the wheel 18 in rotation about its axis 20 with respect to the frame 22. The drive speed of the wheel 18 is dependent on the inclination of the frame 22 measured by the gyroscopic sensor 24. In a neutral position of the frame 22, the speed of the wheel 18 is nil. When the frame 22 is inclined toward the front, the speed of the one-wheeled gyropod 16 increases so as to drive it toward the front. A reduction in the inclination slows down the one-wheeled gyropod 16. Conversely, an inclination of the frame 22 toward the rear drives the one-wheeled gyropod 16 in reverse.

The device 10 further comprises two lateral supports able to move along the ground 14. When one of the lateral supports is in contact with the ground 14, the support in question is able to move along the ground 14 by rolling or by sliding. The lateral supports are disposed laterally on either side of the motorized wheel 18 on each side of the axis 26. The lateral supports are remote from the wheel 18 along the axis 20. When they are moving along the ground 14, the lateral supports are oriented so as to accompany the movement of the device 10, notably in a straight line in the horizontal direction 26. When the frame 22 is balanced, without an inclination with respect to the horizontal direction 26, the motorization of the wheel 18 being deactivated, the lateral supports may be disposed vertically with respect to the axis 20. In other words, the lateral supports each provide a symmetrical support during the movement of the device 10 toward the front or toward the rear. As an alternative, it is possible for the supports to be offset either toward the front or toward the rear of the device 10 in order to favor one of the movements of the device 10. More specifically, by disposing the supports toward the rear of the device 10, the rearward movement of said device will be restrained by the supports when they come into contact with the ground 14 by limiting the possible inclination of the device 10 toward the rear. By contrast, a greater inclination toward the front will be possible, the movement of the device toward the front being restrained to a lesser extent.

The lateral supports may be pads that are able to slide along the ground 14. It is possible to equip the pads with surfaces having a low coefficient of friction in order to reduce the friction on the ground 14. It is possible to give said pads the form of a rounded dome in order to prevent the pads from getting caught on irregularities in the ground 14. To further reduce the friction in relation to the ground, the lateral supports may each comprise a lateral caster, respectively 28 and 30, the casters being intended to roll along the ground 14. The casters 28 and 30 are each able to rotate with respect to a mount, respectively 32 and 34, connected to the frame 22.

In addition, the device 10 comprises a mechanism for braking each of the lateral supports in terms of their movement along the ground 14. The braking is dependent on a reaction force exerted by the ground 14 on the lateral support in question. The braking occurs both when the lateral support in question is moving and when the lateral support is at a standstill on the ground, thus braking the movement of the support with respect to the ground 14.

When the supports on the ground take the form of pads having a low coefficient of friction that are able to slide along the ground 14, it is possible for this sliding action to be braked by providing a second pad having a greater coefficient of friction bearing against the ground 14 in parallel with the first pad. The force of the second pad on the ground 14 being dependent on the force of the lateral support in relation to the ground.

The braking mechanism is not shown in FIG. 1. It may take multiple forms. When a lateral support in the form of a caster 28 or 30 exerts a force on the ground 14, this force is absorbed by the frame 22 by means of the corresponding bracket 32 or 34. The greater the force of the caster on the ground, the greater the braking of said caster. More specifically, when the caster brushes the ground 14 and exerts virtually no force on the ground, the caster can rotate freely and accompanies the device 10 in a straight line along the axis 26. When the caster increases its force on the ground, its rotation with respect to the corresponding mount is braked and the device 10 is caused to turn, the instantaneous center of rotation of which is situated on the side of the braked caster. When one of the casters increases its force on the ground, the opposite caster reduces its own and does not oppose the turning of the device 10. The braking may go so far as to block the caster with respect to its mount, thus leading to a sharp turn the center of rotation of which is the contact point between the caster and the ground. This type of turn of the device 10 may be equated to a pirouette, in which the device 10 can virtually rotate on the spot.

The braking mechanism may for example comprise pads that are able to clamp the rims of the caster. The pressing of the pads is controlled by the movement of a slide connecting the mount of the caster to the frame 22. The slide is provided with a return spring tending to move the pads away. When the caster bears against the ground 14, the reaction of the ground on the caster tends to compress the return spring, leading to the movement of the slide and the pressing of the pads against the rims. The implementation of a spring ensures a linear relationship between the bearing of the caster against the ground and the braking force of the caster.

FIG. 2 shows a perspective view of a more specific example of the device 10 equipped with the casters 28 and 30, and implementing another example of a braking mechanism. The wheel 18, the frame 22, the casters 28 and 30 and their respective mount 32 and 34 are shown. FIG. 3 shows a front view of the same device 10 in a plane containing the axis 20 of the wheel 18. In FIG. 3, the device is balanced on these two casters 28 and 30. In other words, the pressure exerted by each of the casters 28 and 30 on the ground 14 is substantially equal. In this example, a pad, respectively 40 and 42, is configured to bear directly against the ground 14 in order to brake the movement of the corresponding caster along the ground. The bearing of the pads 40 and 42 against the ground 14 is of a sliding nature. The more the pressing of the pad 40 or 42 against the ground 14 increases, the more the caster speed with respect to the ground 14 is reduced with respect to the speed of the wheel 18, causing the device 10 to turn.

Each pad 40 and 42 is secured to the mount of the corresponding caster 28 and 30. To enable the bearing and the pressing of the pads 40 and 42 against the ground 14, each braking mechanism comprises a pivot connection, respectively 44 and 46, about a horizontal axis perpendicular to the axis of the wheel 18. Each of the pivot connections 44 or 46 connects the corresponding mount 32 or 34 to the frame 22. A return spring, respectively 48 and 50, is disposed between the corresponding mount 32 or 34 and the frame 22. The return spring 48 or 50 tends to move the corresponding pad 40 or 42 away from the ground 14 and allows the rolling of the corresponding caster 28 or 30 in the absence of force between the caster and the ground 14. More specifically, the tension of the return spring 48 or 50 increases with the pressure of the caster 28 or 30 on the ground 14.

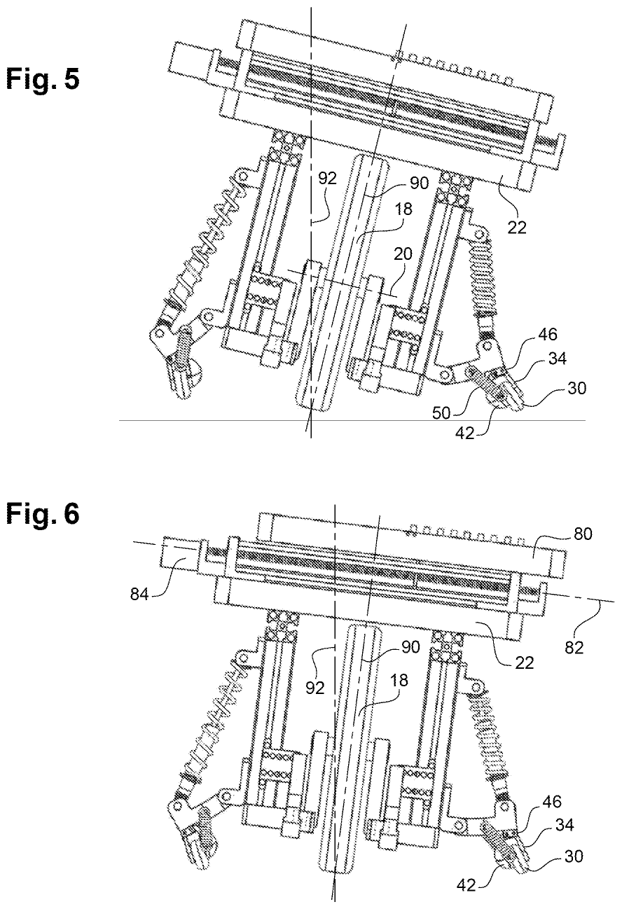

FIGS. 4 and 5 show two positions of the device 10 in FIG. 2. As a reminder, the device is balanced in FIG. 3. In other words, the axis 20 of the wheel 18 is horizontal. In FIG. 4, a pressure is exerted laterally on the frame 22. The mount 34 starts to incline with respect to the frame 22 by rotating about the pivot connection 46. The return spring 50 stiffens and the pad 42 draws near to the ground 14. In FIG. 5, the pressure exerted laterally on the frame 22 increases further. The mount 34 inclines further with respect to the frame 22 and the pad 42 comes into contact with the ground 14.

In the example shown, the return springs 48 and 50 increase in terms of their length when the reaction force of the ground 14 on the corresponding caster 28 or 30 increases. As an alternative, it is possible to provide springs whose length decreases when the reaction force increases. It is also possible to provide centered spiral springs around each pivot connection 44 and 46.

It is possible to make each of the pivot connections 44 and 46 rotate directly with respect to the frame 22. Likewise, when the lateral supports take the form of pads, these pads may be fastened directly to the frame 22. However, it is advantageous to give flexibility to the connection between the lateral supports and the frame 22. This flexibility may be implemented with a small amount of travel by means of a flexible material for example made of natural rubber or made of an elastomer allowing shocks and vibrations to be absorbed. It is beneficial to select a material exhibiting properties of elasticity and of damping. The flexibility may be implemented with a greater amount of travel by means of a sliding connection, respectively 52 and 54, connecting the frame 22 to the corresponding lateral support, a spring, respectively 56 and 58, tending to return the sliding connection to a medial position, and a damper, respectively 60, 62, for damping the movements of the sliding connection around its central position. In practice, the sliding connection, the spring and the damper may be implemented by means of a spring-type hydraulic damper of the type of those equipping a number of motor vehicles. Each sliding connection is oriented so as to move the lateral support in question with respect to the frame 22 during a lateral inclination of the frame 22. More specifically, in the presence of the springs 56 and 58, the more the reaction force of the ground 14 on one of the casters 28 or 30 increases, the more the relevant damper 60 or 62 compresses. The sliding connection 52 allows the caster 28 to slide along an axis 53 with respect to the frame 22. Likewise, the sliding connection 54 allows the caster 30 to slide along an axis 55 with respect to the frame 22. The axes 53 and 55 may be vertical when the device is laterally and longitudinally balanced. As an alternative, as shown in the figure, the axes 53 and 55 may be inclined with respect to the vertical in order to facilitate the disposition of the different mechanical components of the device and the reaction of forces by the frame 22.

The sliding connections 52 and 54 may be mounted in cantilevered fashion and therefore held only by a single end on the frame 22. However, it is preferable to provide a mounting in the form of a deformable triangle. More specifically, the device 10 comprises a lever, respectively 64, 66, associated with each of the casters 28 and 30. Each lever 64 and 66 being articulated to the frame 22 at one point, respectively 68, 70, and to one end of the corresponding sliding connection 52, 54 at another separate point, respectively 72, 74. The other end of the sliding connection is articulated to the frame 22. The pivot connection 44 or 46 connects the corresponding mount 32 or 34 to the lever 64 or 66. The return spring 48 or 50 is disposed between the mount 32 or 34 and the corresponding lever 64 or 66.

In order to control the device 10, a user may take up position directly on the frame 22. The user may for example be seated, as shown in FIG. 1. To this end, a seat may be fastened on the frame 22. When the user leans their upper body toward the front or toward the rear, the motorization of the wheel 18 is controlled as a function of the inclination of the user. Furthermore, when the user leans their upper body laterally, the force exerted by one of the casters 28 or 30 on the ground 14 increases, from the position in FIG. 3 to the position in FIG. 4 and then the position in FIG. 5. By combining the inclination of the upper body toward the front or the rear and to one of the sides, turns become possible. A pronounced inclination to one of the sides makes it possible to block the movement of the device at one of the pads 40 or 42. By combining this pronounced lateral inclination with an inclination toward the front driving the rotation of the wheel 18, the device is able to rotate on itself about the point at which the ground bears against the immobile pad.

It is possible to adapt the device 10 for a user with mobility problems preventing them from inclining their upper body. To assist this user, it is possible to equip the device with a platform 80 vertically above the frame 22. The platform 80 is configured such that the user is able to take up position thereon. A base may notably be fastened thereto. The platform 80 is movable in translation with respect to the frame 22 along an axis 82 parallel to the axis 20 of the wheel 18. An actuator 84 makes it possible to motorize the movement of the platform 80 with respect to the frame 22 along the axis 82. The movement of the platform 80 makes it possible to compensate for the lateral mobility problems of the user. The actuator 84 is also very useful for the movement of an immobile load disposed on the platform 80 in the place of the user 12. In the absence of a load disposed on the platform 80, the maneuvering of the actuator 84, by moving the platform 80, makes it possible to move the weight of the device and therefore to laterally incline the device and modify the bearing actions on the casters 28 and 30. To control the actuator 84, the device comprises a data input module and a module for controlling the actuator so as to move the platform 80 with respect to the frame 22 as a function of data from the data input module. The data input module may take different forms, such as a ministick, better known as a joystick, or a camera making it possible for example to identify very slight movements of a part of the user's body. The data input module may also be remote from the device 10 in order to be commanded by an external operator who is not on board the device 10.

In FIG. 3, the platform 80 is in a central position ensuring that the device 10 is in a laterally balanced position. In FIGS. 4 and 5, the actuator 84 is not maneuvered and the user can lean laterally, so as to modify the force exerted by each of the casters 28 and 30 on the ground 14. FIGS. 6 and 7 show two positions of the platform 80 in which the actuator 84 is maneuvered so as to move the weight of the user's body in translation along the axis 82. The more the platform 80 moves away from its central position, the more the caster 30 bears against the ground 14 and the more its mount 34 inclines, until the position in FIG. 7 in which the pad 42 comes into contact with the ground 14.

It is also possible to provide a movement in translation of the platform 80 from front to rear, that is to say along a horizontal axis 26 perpendicular to the axis 82 in order to assist the user if they have difficulties with leaning forward and rearward. The movement in translation along the axis 26 is also very useful for the movement of an immobile load disposed on the platform 80.

FIG. 8 shows a top view of the device 10 and illustrates the possible presence of a plurality of stops that are secured to the frame 22 and that are configured to bear against the ground 14 when the device reaches an acceptable maximum inclination. More specifically, for the device 10, it is possible to define an axis 90 passing through the center of the wheel 18 and through a contact point 88 of the wheel 18 with the ground 14. In the position in FIG. 3, the axis 90 is vertical. The axis 90 is inclined laterally in the positions of the device 10 that are shown in FIGS. 4, 5, 6 and 7. More specifically, the axis 90, specific to the device 10 itself, may be inclined with respect to a vertical axis 92 also passing through the contact point of the wheel 18 with the ground 14. FIGS. 4, 5, 6 and 7 are concerned with a lateral inclination. The axis 90 may also be inclined toward the front or the rear, this making it possible to control the motorization of the wheel 18. In the example in FIG. 8, four stops 94, 96, 98 and 100 are shown. The stop 94 is situated at the front right of the device 10. The stop 96 is situated at the rear right, the stop 98 is situated at the rear left and the stop 100 is situated at the front left of the device 10. It is possible to provide a different number of stops. The position of the stops 94, 96, 98 and 100 with respect to the frame 22 may be adjustable notably in order to adapt the control of the device to the agility of the user. This is beneficial in particular when the device 10 is used for functional re-education of the user. In the course of re-education, the stops 94, 96, 98 and 100 could be moved so as to reduce the limitation of the maximum inclination of the frame 22 as the user becomes more confident in the control of the device 10. To this end, as is visible in FIG. 2, the fastening of the stop 96 to the frame 22 may be moved for example along a vertical sliding connection 102 and through various fastening points 104 making it possible to move the stop 96 away from the wheel 18. The other stops 94, 98 and 100 also have the same position settings.

FIG. 9 illustrates, in the form of a block diagram, an example of operation of the device 10. The device 10 comprises a control module, also called controller 110, receiving different input data allowing the control of the device 10 and processing this data to ensure the command of the different actuators of the device 10. The controller 110 may comprise a microcontroller-based electronic module. Among the input data, it is possible to distinguish data from sensors and data from a data input module, also called human-machine interface 112, allowing the control of the device. The human-machine interface 112 may be fastened to the device 10. This notably allows a user seated on the platform 80 to input data for the controller 110. The human-machine interface 112 may be remote and connected to the controller 110 for example by means of a wireless connection, this making control or programming possible remotely from the vehicle. It is also possible to provide two housings fulfilling the function of human-machine interface 112, one fastened to the vehicle and the other remote.

Among the sensors, it is possible to distinguish sensors measuring the parameters of the device itself, called chair sensors 114, and sensors measuring the attitude of the user, called driver sensors 116. The chair sensors 114 notably comprise the inclination sensors of the frame 22 and inertial sensors. In addition, among the chair sensors 114, it is possible to equip the casters 28 and 30 and the stops 94, 96, 98 and 100 with sensors for detecting contact with the ground 14. The driver sensors 116 may comprise means for detecting the position or the movement of the user or a force exerted by said user. For example, when the user is seated on the platform 80, it is possible to detect the position, the variations in inclination and more generally the movements of the user or a part of their body. It is also possible to detect the forces exerted by the user on an element of the platform 80. These detection operations may be implemented by different types of sensors, optical sensors, force sensors, etc. The user may also be situated remotely from the device 10 and may control said device by means of driver sensors 116 that are remote from the device and that are connected to the controller 110 for example by means of a wireless connection.

The human-machine interface 112 allows symbolic data to be input. The human-machine interface 112 can be equipped with a means for inputting tactile data, such as a keyboard, a trackball, a joystick, a touchscreen, etc. The human-machine interface 112 makes it possible to input data allowing the immediate control of the device 10 or allowing the control thereof to be programmed. The input data may notably relate to the commands of the wheel 18, of the actuator 84 and of any other actuator of the device, such as an actuator that makes it possible to motorize the movement in translation of the platform 80 from front to rear. In the programming, it is possible to provide a plurality of control modes adapted to the type of user. It is for example possible to offer a “beginner” mode, in which the speed limitations are lower than in an “advanced” mode. In the programming, it is also possible to enable or disable the use of certain driver sensors. Still in the programming, it is possible to provide a completely autonomous mode for the device following a path provided in advance. More generally, the controller 110 is parameterizable and the human-machine interface 112 makes it possible to modify the parameterization of the controller 110. The human-machine interface 112 may also comprise an emergency stop button for stopping all motorization of the device 10. It is possible to motorize the stops 94, 96, 98 and 100 to make them descend in the event of an emergency stop in order to reduce the possibility of lateral and longitudinal inclination of the frame 22.

The controller 110 may generate different types of commands 118, including, essentially, the command of the motorization of the wheel 18 that is shown in box 120 and that notably makes it possible to make the device 10 move forward or backward along the axis 26. As has been seen above, the command of the motorization of the wheel 18, associated with the braked bearing action of one of the casters 28 or 30, allows the device to be controlled in a curve. When the actuator 84 is present, and possibly an actuator making it possible to move the platform 80 longitudinally along the axis 26, the controller 110 generates the command or commands shown in box 122 therefor.

The controller 110 may also store the control data and the commands over a given period of time in order to subsequently analyze them, notably in the form of an activity report of the user 12. The storage and the processing of the stored data are shown symbolically in box 124 under the designation: “evaluations”. This is very useful for example when the device is used for functional re-education of the user. The report on their activity makes it possible to measure the progress of the re-education.

1. A device for assisting the movement of a load along a surface, the device comprising:
a one-wheeled gyropod equipped with a motorized wheel rotating about an axis, the wheel being intended to roll along the surface, with a frame with respect to which the wheel is motorized, and with at least one gyroscopic sensor making it possible to measure an inclination of the frame with respect to a horizontal direction perpendicular to the axis of rotation of the wheel, the gyroscopic sensor controlling the motorization of the wheel,
two lateral supports connected to the frame and able to move along the surface,
a mechanism for braking each of the two lateral supports, configured to brake the movement of the lateral support in question with respect to the surface as a function of a reaction force exerted by the surface on the lateral support in question.

2. The device as claimed in claim 1, wherein each lateral support comprises a lateral caster able to roll along the surface, each being able to rotate with respect to a mount connected to the frame.

3. The device as claimed in claim 2, wherein each braking mechanism comprises a pivot connection about a horizontal axis perpendicular to the axis of the wheel, the pivot connection connecting the mount to the frame, a pad secured to the mount being able to bear against the surface alternatingly with the rolling of the lateral caster along the surface, a return spring disposed between the mount and the frame tending to move the pad away from the surface and allowing the rolling of the lateral caster in question in the absence of reaction force exerted by the surface on the lateral caster in question.

4. The device as claimed in claim 1, wherein each of the lateral supports is connected to the frame by means of a sliding connection connecting the frame to the corresponding lateral support, a spring tending to return the sliding connection to a medial position, and a damper for damping the movements of the sliding connection around its central position, the orientation of each sliding connection being defined so as to allow a compression of the damper in question when a reaction force of the surface on the lateral support in question increases.

5. The device as claimed in claim 3, further comprising a lever associated with each of the casters, each lever being articulated to the frame at one point and to one end of the corresponding sliding connection at another separate point, the other end of the sliding connection being articulated to the frame, the pivot connection connecting the corresponding mount to the lever, the return spring being disposed between the mount and the lever.

6. The device as claimed in claim 1, further comprising a platform configured to receive the load, the platform being movable in translation with respect to the frame along an axis of translation parallel to the axis of the wheel, an actuator making it possible to move the platform with respect to the frame along the axis of translation, a human-machine interface configured to allow a user to control the device, and a controller making it possible to command the actuator so as to move the platform with respect to the frame as a function of data from the human-machine interface.

7. The device as claimed in claim 6, comprising at least one attitude sensor for a user having taken up position on the device, the controller being configured to control the motorized wheel as a function of data from the attitude sensor.

8. The device as claimed in claim 7, wherein the controller is configured to control the actuator making it possible to move the platform as a function of data from the gyroscopic sensor and/or the attitude sensor.

9. The device as claimed in claim 6, wherein the controller is parameterizable.

10. The device as claimed in claim 1, further comprising means for storing control and command data for the motorization of the wheel over a given period of time and for processing this data so as to edit an activity report of a user having taken up position on the device.

11. The device as claimed in claim 1, further comprising a plurality of stops secured to the frame and configured to bear against the surface when the device reaches an inclination of an axis passing through the center of the wheel and through a contact point of the wheel with the surface during the rolling of the wheel along the surface with respect to a vertical axis passing through the contact point of the wheel, the stops being distributed about the axis passing through the center of the wheel and through the contact point of the wheel with the surface during rolling.

12. The device as claimed in claim 11, wherein the position of the stops with respect to the frame is adjustable.
